(19) United States
(12) Patent Application Publication
(10) Pub. No.: US 2016/0247317 A1
(43) Pub. Date: Aug. 25, 2016

(54) SEGMENTING A THREE DIMENSIONAL SURFACE MESH USING A CONTINUOUS TARGET FUNCTION

(71) Applicant: Yowza LTD., Tel Aviv (IL)

(72) Inventors: Susanne Pielawa, Tel Aviv (IL); David Lehavi, Haifa (IL)

(21) Appl. No.: 14/630,722

(22) Filed: Feb. 25, 2015

(51) Int. Cl. G06T 17/20

(52) U.S. Cl. CPC G06T 17/20; G06T 2200/04

(57) ABSTRACT

A computer implemented method, the method comprises: receiving or generating a mesh, wherein the mesh is a three dimensional surface mesh that comprises multiple vertexes and represents a three dimensional object; assigning an initial vertex weight to each vertex of the multiple vertexes; calculating, in response to multiple initial vertex weights of the multiple vertexes, an initial cut curve that passes through arcs that connect vertexes having initial vertex weights of opposite signs; wherein the initial cut curve segments the mesh to multiple parts; searching, by applying an iterative process, for a desired cut curve; wherein the desired cut curve is selected in response to multiple values of a continuous target function that are associated with multiple iterations of the iterative process; wherein during each iteration of the iterative process a value of the continuous target function is responsive to values assigned to vertexes during the iteration.

### BACKGROUND OF THE INVENTION

Three dimensional objects may be represented by a three dimensional surface mesh that includes a plurality of faces.

There is a growing need to segment the three dimensional surface mesh to meaningful parts.

### SUMMARY

There may be provided a non-transitory computer readable medium that may store instructions that once executed by a computer cause the computer to execute the stages of: receiving or generating a mesh, wherein the mesh may be a three dimensional surface mesh that may include multiple vertexes and represents a three dimensional object; assigning an initial vertex weight to each vertex of the multiple vertexes; calculating, in response to multiple initial vertex weights of the multiple vertexes, an initial cut curve that passes through arcs that connect vertexes having initial vertex weights of opposite signs; wherein the initial cut curve segments the mesh to multiple parts; searching, by applying an iterative process for a desired cut curve; wherein the desired cut curve may be selected in response to multiple values of a continuous target function that are associated with multiple iterations of the iterative process; and wherein during each iteration of the iterative process a value of the continuous target function may be responsive to values assigned to vertexes during the iteration.

The searching of the desired cut may include searching for a global or local optimum of the continuous target function.

Each iteration of the iterative process may include: assigning an intermediate vertex weight to each vertex of the multiple vertexes; calculating, in response to multiple intermediate vertex weights of the multiple vertexes, an intermediate cut curve that passes through arcs that connect vertexes having intermediate vertex weights of opposite signs; wherein the intermediate cut curve represents an intermediate segmentation of at least a portion of the mesh to intermediate segments; and calculating, using the continuous target function, a value of the intermediate segmentation.

The value of the intermediate segmentation may be responsive to (a) a length of the intermediate cut curve and (b) a sum of a reciprocal of an area of a first intermediate segment of the multiple intermediate segments and a reciprocal of an area of a second segment of the multiple intermediate segments.

The value of the intermediate segmentation may be proportional to a product of a multiplication between (a) the length of the intermediate cut curve and (b) a square root the sum of the reciprocal of the area of the first intermediate segment and the reciprocal of the area of the second intermediate segment.

The assigning of the multiple intermediate vertex weights, during a certain iteration of the multiple iterations, may be responsive to multiple intermediate vertex weights assigned during a previous iteration of the multiple iterations.

The assigning of the multiple intermediate vertex weights, during a certain iteration of the multiple iterations, may be responsive to multiple intermediate vertex weights assigned during a plurality of previous iterations of the multiple iterations.

The assigning of the multiple intermediate values, during a certain iteration of the multiple iterations, may be responsive to a gradient of the continuous target function at a point that corresponds to an intermediate cut curve calculated during the certain iteration.

The iterative process may include applying a gradient descent process.

The iterative process may include applying a simulated annealing process.

The location of a crossing point between a certain arc of a face and the initial cut curve may be responsive to initial vertex weights assigned to vertexes that are linked by the certain arc.

The a portion of the initial cut curve that passes through a certain face of the mesh may be a straight line that connects between a pair of crossing points between the initial cut curve and a pair of arcs of the face.

A portion of the initial cut curve that passes through a certain face of the mesh may be a non-linear curve that connects between a pair of crossing points between the initial cut curve and a pair of arcs of the face.

There may be provided a computer implemented method, the method may include receiving or generating a mesh, wherein the mesh may be a three dimensional surface mesh that may include multiple vertexes and represents a three dimensional object; assigning an initial vertex weight to each vertex of the multiple vertexes; calculating, in response to multiple initial vertex weights of the multiple vertexes, an initial cut curve that passes through arcs that connect vertexes having initial vertex weights of opposite signs; wherein the initial cut curve segments the mesh to multiple parts; searching, by applying an iterative process, for a desired cut curve; wherein the desired cut curve may be selected in response to multiple values of a continuous target function that are associated with multiple iterations of the iterative process; wherein during each iteration of the iterative process a value of the continuous target function may be responsive to values assigned to vertexes during the iteration.

There may be provided a device that may include a memory unit and a processor, wherein the processor may be configured to receive or generate a mesh, wherein the mesh may be a three dimensional surface mesh that may include multiple vertexes and represents a three dimensional object; assign an initial vertex weight to each vertex of the multiple vertexes; calculate, in response to multiple initial vertex weights of the multiple vertexes, an initial cut curve that passes through arcs that connect vertexes having initial vertex weights of opposite signs; wherein the initial cut curve segments the mesh to multiple parts; search, by applying an iterative process, for a desired cut curve; wherein the desired cut curve may be selected in response to multiple values of a continuous target function that are associated with multiple iterations of the iterative process; wherein during each iteration of the iterative process a value of the continuous target function may be responsive to values assigned to vertexes during the iteration.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates a method according to an embodiment of the invention;

FIG. 2 illustrates a segmentation of a portion of a mesh according to an embodiment of the invention;

FIG. 3 illustrates a segmentation of a portion of a mesh according to an embodiment of the invention; and

FIG. 4 illustrates a system according to an embodiment of the invention.

### DETAILED DESCRIPTION OF THE DRAWINGS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system should be applied mutatis mutandis to a method that may be executed by the system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

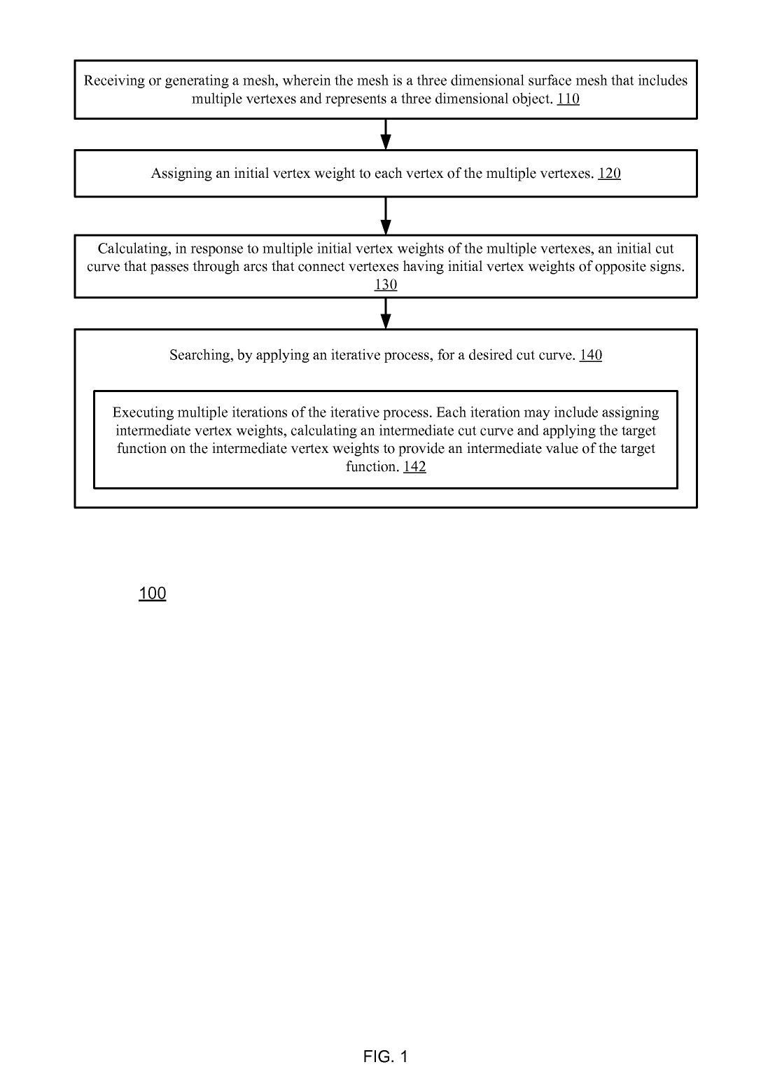

FIG. 1 illustrates method 100 according to an embodiment of the invention.

Method 100 may start by step 110 of receiving or generating a mesh, wherein the mesh is a three dimensional surface mesh that includes multiple vertexes and represents a three dimensional object.

Step 110 may be followed by step 120 of assigning an initial vertex weight to each vertex of the multiple vertexes. Each vertex of the entire mesh or of a portion of the mesh may be assigned with a vertex weight.

Each initial vertex weight can be a real number that is indicative of an initial segmentation of the mesh (or a portion of the mesh)—as the sign (positive or negative) of each initial vertex weight may indicate to which initial segment of the mesh the vertex belongs. An initial vertex weight of zero may be ignored or may indicate that the vertex is located on an initial cut curve.

Two vertexes are linked to each other by a single arc.

Arcs that connect vertexes that have initial vertex weights of the same sign can be ignored of (they are inactive arcs)—as they do not contribute to the calculation of the initial cut curve.

Arcs that connect vertexes that have initial vertex weights of opposite signs (active arcs) include crossing points with the initial cut curve.

The initial vertex weights may be allocated in any manner. For example—the initial vertex weights may be assigned in a random manner or in a pseudo random manner or according to a predefined pattern or scheme.

Step 110 may be followed by step 120 of calculating, in response to multiple initial vertex weights of the multiple vertexes, an initial cut curve that passes through arcs that connect vertexes having initial vertex weights of opposite signs. The initial cut curve segments the mesh (or a part of the mesh) to multiple parts.

The calculating of the initial cut curve may include calculating crossing points between the initial cut curve and active arcs.

For example, the calculating may be responsive to values (or absolute values) of the vertex weights of opposite signs determine the location of the crossing point between the arc that connects the vertexes and the initial cut curve.

Especially—the distances from a crossing point (of an active arc and the initial cut curve) and each one of the vertexes of that active arc may be proportional (or inversely proportional) to the absolute values of the weights of the vertexes.

It is noted that the distances may be calculated by applying other functions. For example—the distances may be proportional to the square root (or any positive or negative power) of the absolute values of the initial vertex weights.

For example, assume:

a. X[v] is the value assigned to vertex v, wherein:
i. If X[v]<0 then vertex v is a part of a first segment.
ii. If X[v]>0 then vertex v is a part of a second segment.
iii. If X[v]=0 then vertex v is a part is on a cut curve separating between the first and second segments.

b. A triangular face has three vertexes v1, v2 and v3.

c. Each point P of that face may be represented by barycentric coordinates c1, c2 and c3 as c1*v1+c2*v2+c3*v3, with c1+c2+c3=1, wherein each one of c1, c2 and c3 ranges between 0 and 1.

d. Each point P on the face is assigned a value: X(p)=a1*X[v1]+a2*X[v2]+a3*X[v3].

Under these assumptions the cut curve may be defined with points that have a zero value: X(p)=0.

Step 120 may be followed by step 130 of applying a continuous target function on the initial vertex weights to provide an initial value of the continuous target function.

A continuous cost function that may be used for evaluating one or more cut curves may be represented as a function of the vertex weights (initial or intermediate) assigned to the vertexes. This allows method 100 to apply one or more continuous function optimization processes for searching a desired cut curve.

Non-limiting examples of such continuous function optimization processes are gradient decent and simulated annealing.

These various continuous function optimization processes continuously change (during different iterations of the iterative process) the vertexes value and this change is evaluated by calculating the value of the target function.

Step 130 may be followed by step 140 of searching, by applying an iterative process, for a desired cut curve.

Step 140 may include step 142 of executing multiple iterations of the iterative process. Each iteration may include assigning intermediate vertex weights, calculating an intermediate cut curve and applying the continuous target function on the intermediate vertex weights to provide an intermediate value of the target function.

The calculation of the intermediate cut curve can resemble the calculation of the initial cut curve (step 120) but may differ from the calculation of step 120.

For example—step 140 may search for active arcs and define an intermediate cur curve that crosses the active arcs. The crossing point may be responsive to the intermediate vertex weights assigned to vertexes linked by an active arc.

The intermediate cut curve spans between pairs of adjacent crossing points. Pairs of adjacent crossing points may be linked by a straight line or by a non-linear curve.

The multiple iterations provide multiple values of the target function.

Step 140 may also include selecting the desired cut curve in response to the multiple values of the target function.

One or more selection rules may be applied. For example—the desired cut curve can be selected to be associated with the lowers “energy” or “cost”.

For example - step 140 may search for a desired cut curve that is associated with a local or global optimum (maximum or minimum) of the target function.

The continuous target function may be responsive to attributes of any segmentation (initial or intermediate) performed by the cut curve (initial or intermediate).

If a cut curve performs a segmentation that results in a pair of segments that are divided by the cut curve then the continuous target function may be responsive to a length of the cut curve and to areas of the pair of segments.

For example, the continuous target function may be responsive to the length of the cut curve and to and a sum of the reciprocals of the areas of the first and second segments. Especially the continuous target function may be responsive to a product of a multiplication between (a) the length (L) of the cut curve and (b) a square root the sum of the reciprocals of the areas (A1 and A2) of the first and second segments:

Continuous target function=L*SQR(1/A1+1/A2).

The continuous target function is a function of the vertex weights (X[v]). Referring to the continuous target function mentioned above—each element out of L, A1 and A2 is a function of the vertex weights (initial or intermediate) and should be represented as such. This representation facilitates the applying of continuous function analysis methods such as but not limited to gradient descend.

During each of the iterations, step 140 may include assigning multiple intermediate vertex weights in response to multiple intermediate vertex weights assigned during one or more previous iteration of the multiple iterations.

For example, the assigning of the multiple intermediate values, during a certain iteration of the multiple iterations, may be responsive to a gradient of the continuous target function with respect to the intermediate vertex values calculated during the certain iteration.

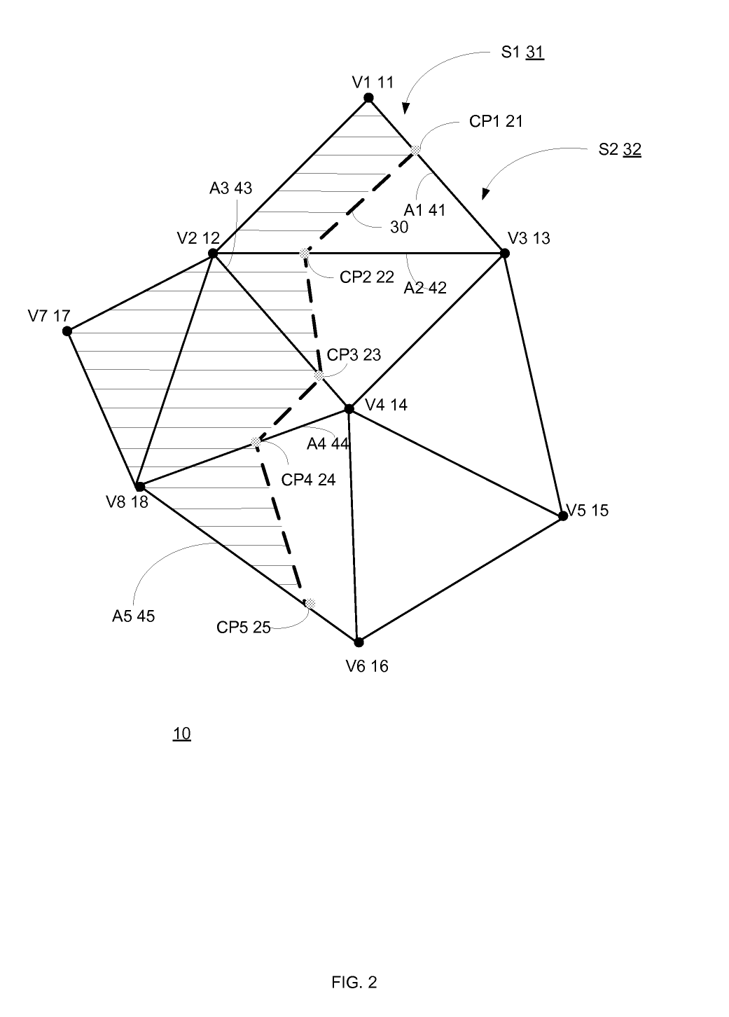

FIG. 2 illustrates an initial cut curve 30 that passes through first till fifth crossing points CP1-CP5 21-25 with active arcs A1 41, A2 42, A3 43, A4 44 and A5 45.

Each one of active arcs 41-45 links vertexes with initial vertex weights of opposite signs.

Active arc A1 41 links vertexes v1 11 and v3 13 that have initial vertex weights of opposite sign.

Active arc A2 42 links vertexes v2 12 and v3 13 that have initial vertex weights of opposite sign.

Active arc A3 43 links vertexes v2 12 and v4 14 that have initial vertex weights of opposite sign.

Active arc A4 44 links vertexes v4 14 and v8 18 that have initial vertex weights of opposite sign.

Active arc AS 45 links vertexes v6 16 and v8 18 that have initial vertex weights of opposite sign.

Vertexes V1 11, V2 12, V7 17 and V8 18 have initial vertex weights of the same sign (for example—positive), belong to initial first segment S1 31 and are linked by inactive arcs.

Vertexes V3 13, V4 14, V5 15 and V6 16 have initial vertex weights of the same sign (for example—negative), belong to initial second segment S2 32 and are linked by inactive arcs.

Initial first and second segments S1 and S2 are separated by initial cut curve and have areas of A1 and A2 respectively.

A continuous target function (such as L*SQR(1/A1+1/A2)) is applied on this initial segmentation to provide an initial value.

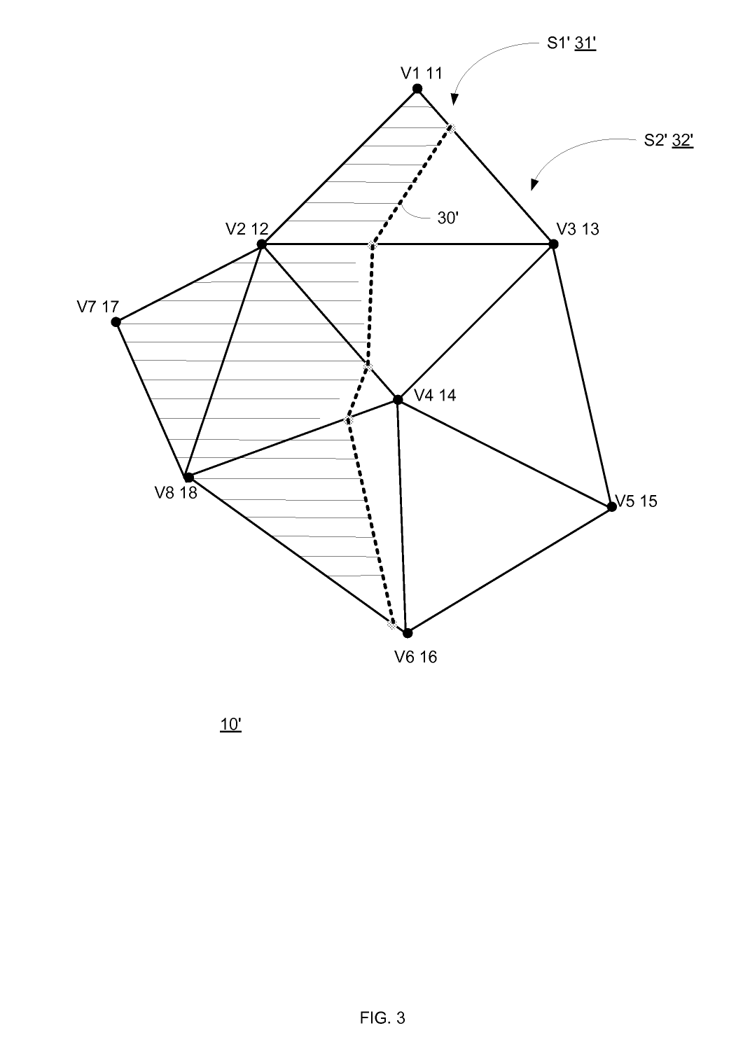

FIG. 3 illustrates a first intermediate cut curve 30′. The first intermediate cut curve is calculated after the initial vertex weights were changed to provide first initial vertex weights. These changes may be computed in various manners.

The first intermediate cut curve 30′ defines intermediate first and second segments SF 31′ and S2′ 32 and have areas of A1′ and A2′ respectively.

A continuous target function (such as L′*SQR(1/A1′+1/A2′)) is applied on this first intermediate segmentation to provide a first intermediate value.

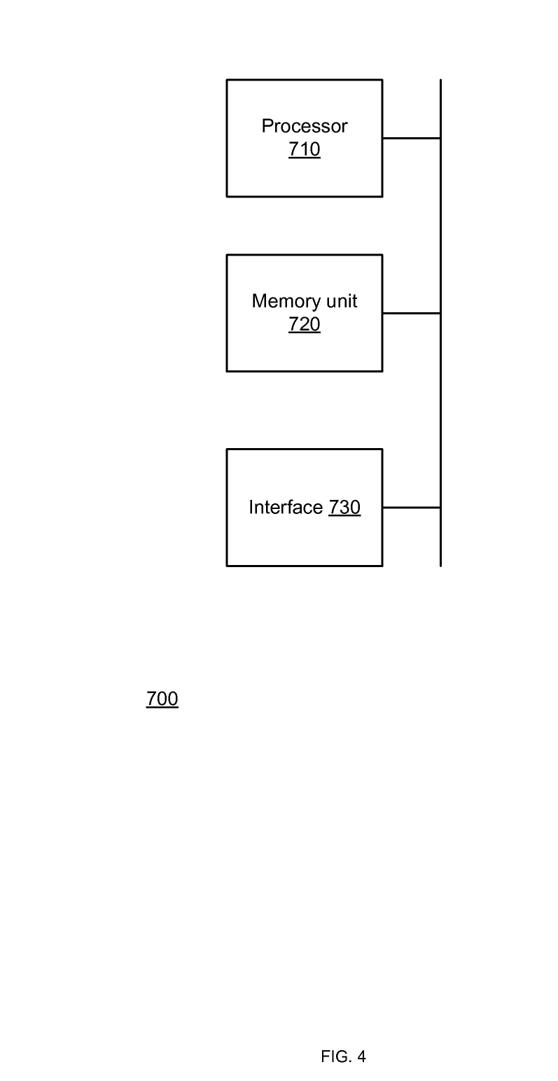

FIG. 4 illustrates a system 700 according to an embodiment of the invention.

System 700 may be one or more computers. System 700 may include, for example, a hardware processor 710, a memory unit 720 and an interface 730 for coupling the system 700 to one or more networks (not shown).

The hardware processor 710 may be a digital signal processor, a central processing unit, an FPGA, a tailored processor and the like. The memory unit 720 may be a volatile memory, a non-volatile memory or a combination of both.

System 700 may be configured to execute method 100.

The memory unit 720 may store instructions that one executed by the processor 710 cause the processor to execute method 100. The memory unit 720 may also store information that represents the mesh as well as the multiple values of the continuous target function that are calculated and evaluated during the execution of method 100.

The segmentation process illustrated in this specification provides a highly accurate and automatic segmentation that is capable of segmenting three dimensional meshes in an accurate manner and may be applied on multiple three dimensional meshes in a reliable manner and to provide segmented three dimensional meshes.

The invention may also be implemented in a computer program for running on a computer system, at least including code portions for performing steps of a method according to the invention when run on a programmable apparatus, such as a computer system or enabling a programmable apparatus to perform functions of a device or system according to the invention. The computer program may cause the storage system to allocate disk drives to disk drive groups.

A computer program is a list of instructions such as a particular application program and/or an operating system. The computer program may for instance include one or more of: a subroutine, a function, a procedure, an object method, an object implementation, an executable application, an applet, a servlet, a source code, an object code, a shared library/dynamic load library and/or other sequence of instructions designed for execution on a computer system.

The computer program may be stored internally on a non-transitory computer readable medium. All or some of the computer program may be provided on computer readable media permanently, removably or remotely coupled to an information processing system. The computer readable media may include, for example and without limitation, any number of the following: magnetic storage media including disk and tape storage media; optical storage media such as compact disk media (e.g., CD-ROM, CD-R, etc.) and digital video disk storage media; nonvolatile memory storage media including semiconductor-based memory units such as FLASH memory, EEPROM, EPROM, ROM; ferromagnetic digital memories; MRAM; volatile storage media including registers, buffers or caches, main memory, RAM, etc.

A computer process typically includes an executing (running) program or portion of a program, current program values and state information, and the resources used by the operating system to manage the execution of the process. An operating system (OS) is the software that manages the sharing of the resources of a computer and provides programmers with an interface used to access those resources. An operating system processes system data and user input, and responds by allocating and managing tasks and internal system resources as a service to users and programs of the system.

The computer system may for instance include at least one processing unit, associated memory and a number of input/output (I/O) devices. When executing the computer program, the computer system processes information according to the computer program and produces resultant output information via I/O devices.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

The connections as discussed herein may be any type of connection suitable to transfer signals from or to the respective nodes, units or devices, for example via intermediate devices. Accordingly, unless implied or stated otherwise, the connections may for example be direct connections or indirect connections. The connections may be illustrated or described in reference to being a single connection, a plurality of connections, unidirectional connections, or bidirectional connections. However, different embodiments may vary the implementation of the connections. For example, separate unidirectional connections may be used rather than bidirectional connections and vice versa. Also, plurality of connections may be replaced with a single connection that transfers multiple signals serially or in a time multiplexed manner. Likewise, single connections carrying multiple signals may be separated out into various different connections carrying subsets of these signals. Therefore, many options exist for transferring signals.

Although specific conductivity types or polarity of potentials have been described in the examples, it will be appreciated that conductivity types and polarities of potentials may be reversed.

Each signal described herein may be designed as positive or negative logic. In the case of a negative logic signal, the signal is active low where the logically true state corresponds to a logic level zero. In the case of a positive logic signal, the signal is active high where the logically true state corresponds to a logic level one. Note that any of the signals described herein may be designed as either negative or positive logic signals. Therefore, in alternate embodiments, those signals described as positive logic signals may be implemented as negative logic signals, and those signals described as negative logic signals may be implemented as positive logic signals.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also for example, the examples, or portions thereof, may implemented as soft or code representations of physical circuitry or of logical representations convertible into physical circuitry, such as in a hardware description language of any appropriate type.

Also, the invention is not limited to physical devices or units implemented in non-programmable hardware but can also be applied in programmable devices or units able to perform the desired device functions by operating in accordance with suitable program code, such as mainframes, minicomputers, servers, workstations, personal computers, notepads, personal digital assistants, electronic games, automotive and other embedded systems, cell phones and various other wireless devices, commonly denoted in this application as ‘computer systems’.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

We claim:

1. A non-transitory computer readable medium that stores instructions that once executed by a computer cause the computer to execute the stages of:
receiving or generating a mesh, wherein the mesh is a three dimensional surface mesh that comprises multiple vertexes and represents a three dimensional object;
assigning an initial vertex weight to each vertex of the multiple vertexes;
calculating, in response to multiple initial vertex weights of the multiple vertexes, an initial cut curve that passes through arcs that connect vertexes having initial vertex weights of opposite signs; wherein the initial cut curve segments the mesh to multiple parts;
searching, by applying an iterative process, for a desired cut curve;
wherein the desired cut curve is selected in response to multiple values of a continuous target function that are associated with multiple iterations of the iterative process;
wherein during each iteration of the iterative process a value of the continuous target function is responsive to values assigned to vertexes during the iteration.

2. The non-transitory computer readable medium according to claim 1 wherein searching of the desired cut comprise searching for a global or local optimum of the continuous target function.

3. The non-transitory computer readable medium according to claim 1 wherein each iteration of the iterative process comprises:
assigning an intermediate vertex weight to each vertex of the multiple vertexes;
calculating, in response to multiple intermediate vertex weights of the multiple vertexes, an intermediate cut curve that passes through arcs that connect vertexes having intermediate vertex weights of opposite signs; wherein the intermediate cut curve represents an intermediate segmentation of at least a portion of the mesh to intermediate segments; and
calculating, using the continuous target function, a value of the intermediate segmentation.

4. The non-transitory computer readable medium according to claim 3 wherein the value of the intermediate segmentation is responsive to (a) a length of the intermediate cut curve and (b) a sum of a reciprocal of an area of a first intermediate segment of the multiple intermediate segments and a reciprocal of an area of a second segment of the multiple intermediate segments.

5. The non-transitory computer readable medium according to claim 4 wherein the value of the intermediate segmentation is proportional to a product of a multiplication between (a) the length of the intermediate cut curve and (b) a square root the sum of the reciprocal of the area of the first intermediate segment and the reciprocal of the area of the second intermediate segment.

6. The non-transitory computer readable medium according to claim 3 wherein the assigning of the multiple intermediate vertex weights, during a certain iteration of the multiple iterations, is responsive to multiple intermediate vertex weights assigned during a previous iteration of the multiple iterations.

7. The non-transitory computer readable medium according to claim 3 wherein the assigning of the multiple intermediate vertex weights, during a certain iteration of the multiple iterations, is responsive to multiple intermediate vertex weights assigned during a plurality of previous iterations of the multiple iterations.

8. The non-transitory computer readable medium according to claim 3 wherein the assigning of the multiple intermediate values, during a certain iteration of the multiple iterations, is responsive to a gradient of the continuous target function at a point that corresponds to an intermediate cut curve calculated during the certain iteration.

9. The non-transitory computer readable medium according to claim 3 wherein the iterative process comprises applying a gradient descent process.

10. The non-transitory computer readable medium according to claim 3 wherein the iterative process comprises applying a simulated annealing process.

11. The non-transitory computer readable medium according to claim 1 wherein a location of a crossing point between a certain arc of a face and the initial cut curve is responsive to initial vertex weights assigned to vertexes that are linked by the certain arc.

12. The non-transitory computer readable medium according to claim 1 wherein a portion of the initial cut curve that passes through a certain face of the mesh is a straight line that connects between a pair of crossing points between the initial cut curve and a pair of arcs of the face.

13. The non-transitory computer readable medium according to claim 1 wherein a portion of the initial cut curve that passes through a certain face of the mesh is a non-linear curve that connects between a pair of crossing points between the initial cut curve and a pair of arcs of the face.

14. A computer implemented method, the method comprises: receiving or generating a mesh, wherein the mesh is a three dimensional surface mesh that comprises multiple vertexes and represents a three dimensional object; assigning an initial vertex weight to each vertex of the multiple vertexes; calculating, in response to multiple initial vertex weights of the multiple vertexes, an initial cut curve that passes through arcs that connect vertexes having initial vertex weights of opposite signs; wherein the initial cut curve segments the mesh to multiple parts; searching, by applying an iterative process, for a desired cut curve; wherein the desired cut curve is selected in response to multiple values of a continuous target function that are associated with multiple iterations of the iterative process; wherein during each iteration of the iterative process a value of the continuous target function is responsive to values assigned to vertexes during the iteration.

15. The method according to claim 14 wherein searching of the desired cut comprise searching for a global or local optimum of the continuous target function.

16. The method according to claim 14 wherein each iteration of the iterative process comprises: assigning an intermediate vertex weight to each vertex of the multiple vertexes; calculating, in response to multiple intermediate vertex weights of the multiple vertexes, an intermediate cut curve that passes through arcs that connect vertexes having intermediate vertex weights of opposite signs; wherein the intermediate cut curve represents an intermediate segmentation of at least a portion of the mesh to intermediate segments; and calculating, using the continuous target function, a value of the intermediate segmentation.

17. The method according to claim 16 wherein the value of the intermediate segmentation is responsive to (a) a length of the intermediate cut curve and (b) a sum of a reciprocal of an area of a first intermediate segment of the multiple intermediate segments and a reciprocal of an area of a second segment of the multiple intermediate segments.

18. The method according to claim 17 wherein the value of the intermediate segmentation is proportional to a product of a multiplication between (a) the length of the intermediate cut curve and (b) a square root the sum of the reciprocal of the area of the first intermediate segment and the reciprocal of the area of the second intermediate segment.

19. The method according to claim 16 wherein the assigning of the multiple intermediate vertex weights, during a certain iteration of the multiple iterations, is responsive to multiple intermediate vertex weights assigned during a previous iteration of the multiple iterations.

20. A device comprising a memory unit and a processor, wherein the processor is configured to receive or generate a mesh, wherein the mesh is a three dimensional surface mesh that comprises multiple vertexes and represents a three dimensional object; assign an initial vertex weight to each vertex of the multiple vertexes; calculate, in response to multiple initial vertex weights of the multiple vertexes, an initial cut curve that passes through arcs that connect vertexes having initial vertex weights of opposite signs; wherein the initial cut curve segments the mesh to multiple parts; search, by applying an iterative process, for a desired cut curve; wherein the desired cut curve is selected in response to multiple values of a continuous target function that are associated with multiple iterations of the iterative process; wherein during each iteration of the iterative process a value of the continuous target function is responsive to values assigned to vertexes during the iteration.
